(19) United States
(12) Patent Application Publication
(10) Pub. No.: US 2003/0204591 A1
(43) Pub. Date: Oct. 30, 2003

(54) Data transmitting apparatus and data receiving apparatus

(75) Inventors: Takashi Ueda, Kashiba-Shi (JP); Akemi Kurumatani, Osaka (JP)

Correspondence Address: BURNS, DOANE, SWECKER & MATHIS, L.L.P., P.O. Box 1404, Alexandria, VA, 22313-1404, US

(73) Assignee: MINOLTA CO., LTD.

(21) Appl. No.: 10/421,877

(22) Filed: Apr. 24, 2003

(30) Foreign Application Priority Data
Apr. 24, 2002 (JP) P2002-122429

(51) Int. Cl. G06F 15/173

(52) U.S. Cl. 709/224

(57) ABSTRACT

The present invention provides a data transmitter (for example, MFP (multi function peripheral)) and a data receiver (for example, computer) capable of suppressing communication traffic. When a request RQ of transmitting device information is received from a computer (a data receiver), an MFP (a data receiver) obtains device information of the MFP and generates XML data BD. A transmitting unit of the MFP transmits both the XML data BD specifying the device information itself and style data SD specifying a display format of the data information at the first transmission. At the update transmission of the device information, the transmitting unit transmits only the XML data BD out of the data BD and SD. The computer stores the style data SD transmitted at the time of the first transmission in a style data storing unit, arranges the XML data BD transmitted for updating device information by using the stored style data SD, and displays the resultant on a display unit.

This application is based on application No. 2002-122429 filed in Japan, the contents of which are hereby incorporated by reference.

### BACKGROUND OF THE INVENTION

1. Field of the Invention

The present invention relates to a technique of transmitting and receiving information (device information) of various devices such as a multi function peripheral (hereinafter, abbreviated as “MFP”).

2. Description of the Background Art

Conventionally, there is a technique of transmitting information (device information) of various devices such as an MFP to an external device (such as a personal computer) and displaying the information on a display of the external device. More concretely, device information (for example, operating state and the like) of the MFP is managed by the MFP itself and transmitted to a personal computer as an external device. In this case, the MFP itself functions as a data transmitter, and the external device (personal computer) functions as a data receiver. An object of transmission/reception is data described in the HTML (HyperText Markup Language) format. On a display of the personal computer as a data receiver, data is displayed on the basis of the received data in the HTML format.

In such a technique, at the time of updating device information one after another, HTML data is transmitted/received one after another, so that relatively large communication traffic occurs. When such a communication traffic occurs, an adverse influence is exerted on the other communication, so that it is preferable to suppress the communication traffic.

### SUMMARY OF THE INVENTION

An object of the present invention is to provide a data transmitting apparatus and a data receiving apparatus capable of suppressing communication traffic.

The present invention is directed to a data transmitting apparatus and a data receiving apparatus.

According to a first aspect of the present invention, a data transmitting apparatus comprises a generating part for obtaining device information regarding a predetermined device and generating body data specifying the device information itself, a receiving part for receiving a request to transmit the device information from an external device, a transmitting part for transmitting data, a storing part for storing style data specifying a display format of the device information, and a controller for transmitting both the body data and the style data in a preceding transmission responding to the request, and for transmitting only the body data but not the style data in transmissions subsequent to the preceding transmission.

The body data of the device information is transmitted separately from the style data in the subsequent transmission, so that communication traffic at the time of updating and transmitting device information can be suppressed.

According to a second aspect of the present invention, a data receiving apparatus comprises a receiving part for receiving data, a transmitting part for transmitting data, a storing part for storing data, and a controller for transmitting a request to transmit device information regarding a predetermined device to a data transmitting apparatus, storing style data specifying a display format of the device information into the storing part, receiving body data specifying the device information itself transmitted from the data transmitting apparatus in response to the request, and displaying the body data in accordance with the display format specified in the style data.

With the configuration, a display output regarding device information can be controlled on the basis of the style data stored in the storing part and received body data, so that communication traffic at the time of updating and receiving device information can be suppressed.

The present invention is also directed to a computer program product.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a general configuration of a system;

FIG. 2 is an external view of an MFP;

FIG. 3 is a block diagram showing the MFP;

FIG. 4 is a block diagram showing the hardware configuration of an external device (computer);

FIG. 5 is a flowchart showing the operation of the MFP;

FIG. 6 is a flowchart showing the operation of the external device (computer);

FIG. 7 is a conceptual diagram showing an example of XML data;

FIG. 8 is a conceptual diagram showing an example of style data style sheet);

FIG. 9 is a diagram showing an example of display on a computer;

FIG. 10 is a conceptual diagram for describing operation in a second preferred embodiment;

FIG. 11 is a diagram showing XML data transmitted in the second preferred embodiment;

FIG. 12 is a diagram showing a style sheet transmitted in the second preferred embodiment;

FIG. 13 is a diagram showing a screen displayed in a display format SL1;

FIG. 14 is a diagram showing a screen displayed in a display format SL2;

FIG. 15 is a conceptual diagram for describing operation in a third preferred embodiment;

FIG. 16 is a diagram showing a screen for urging the user to select a display format;

FIG. 17 is a diagram showing a screen displayed in a display format SL11;

FIG. 18 is a diagram showing a screen displayed in a display format SL12;

FIG. 19 is a diagram showing a screen displayed in a display format SL13;

FIG. 20 is a diagram showing a screen displayed in a display format SL14;

FIG. 21 is a flowchart showing the operation of an MFP according to the third preferred embodiment;

FIG. 22 is a flowchart showing the operation of a computer according to the third preferred embodiment;

FIG. 23 is a conceptual diagram for describing a modification; and

FIG. 24 is a conceptual diagram for describing another modification.

### DESCRIPTION OF THE PREFERRED EMBODIMENTS

Hereinafter, preferred embodiments of the present invention will be described with reference to the drawings.

A. First Preferred Embodiment

A1. General Configuration

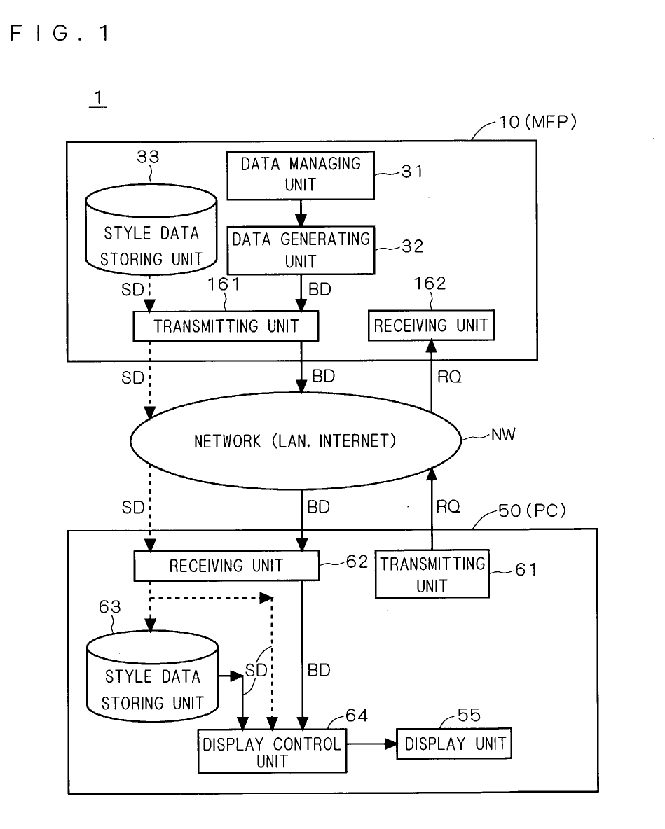

FIG. 1 is a schematic diagram showing a general configuration of a system 1 according to a preferred embodiment of the present invention. The system 1 has a multi function peripheral (hereinafter, abbreviated as “MFP”) 10 and an external device 50.

Each of the MFP 10 and the external device 50 are connected to a network NW and can transmit/receive various data including device information (which will be described later) to/from each other via the network NW. The “network” is a communication line network for performing data communication and, concretely, any of various communication line networks constructed by electric communication lines (including optical communication lines), such as LAN, WAN and the Internet. A form of connection to the network may be always-on connection using a dedicated line or the like or temporary connection such as dial-up connection using a public telephone line such as an analog line or a digital line (ISDN). The transmission method may be a radio method or a wired method.

The MFP 10 is a composite device having the functions of a scanner, a copier, a printer, a facsimile and the like. As will be described later, the MFP 10 has the WWW (World Wide Web) server function and has a function of transmitting device information of the MFP 10 itself in response to a transmission request from the external device 50 as a client. That is, the MFP 10 functions as a data transmitter for transmitting device information to the external device 50.

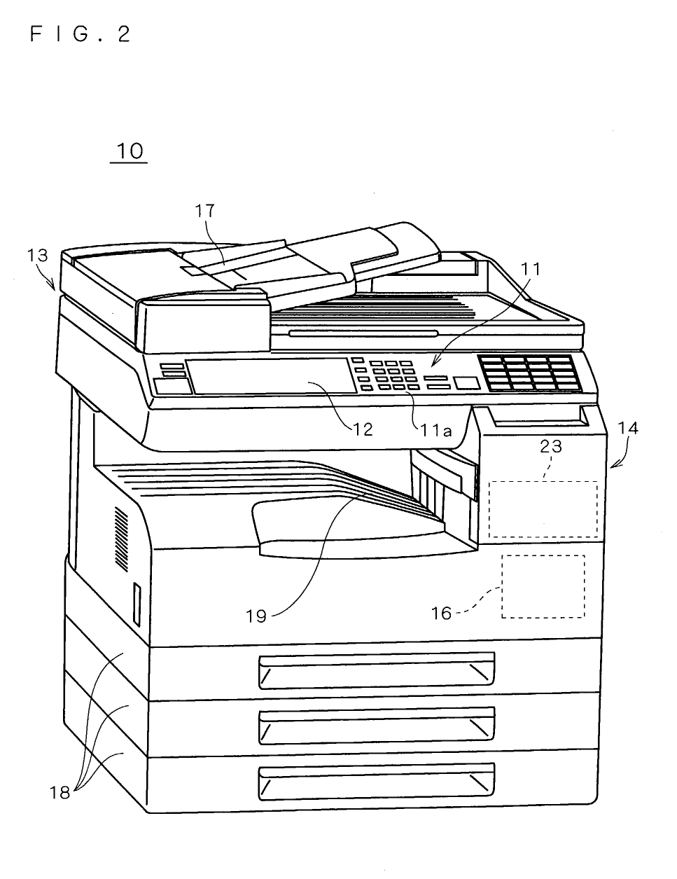

The “device information” denotes information regarding the configuration, operation and the like of a predetermined device such as the MFP 10. For example, the “device information” includes information of the size (letter size, A4 size, B4 size and the like) of sheets stored in paper trays of a paper feeding unit 18 (see FIG. 2) in the MFP, information of the types of paper (plain paper, color paper, OHP paper and the like) in the paper trays, status information (normal, abnormal and the like) of operating conditions, and history information (fax report and the like). Since the “device information” is information for managing a predetermined device (for example, the MFP 10), it can be also expressed as management information.

The external device 50 is a network terminal which can be connected to the network NW and can perform communication with the MFP 10 via the network. For example, a personal computer, a portable telephone, a digital camera, a PDA, an MFP or the like functions as the external device 50. In the following, the case of using a personal computer as the external device 50. The external device 50 can display device information transmitted from the MFP 10 on a predetermined display. Consequently, the operator of the external device 50 can recognize the device information of the MFP 10 on the display of the external device 50.

The MFP 10 has the WWW server function. Based on the function, the MFP 10 can perform communication conformed with a protocol such as the HTTP (HyperText Transfer Protocol) with the external device 50 connected to a network. The MFP 10 transmits the “device information” to the external device 50 by using various protocols.

In order to display the device information on the external device 50, the MFP 10 transmits (1) “body data” specifying data itself of the device information, and (2) “style data” specifying the display format of the device information at the time of displaying the device information on the external device 50. The “body data” can be also expressed as data other than the data specifying the display format (or the display style).

In the preferred embodiment, the “body data” is written as data XML data) in the XML (eXtensible Markup Language) format data. As the “style data”, a style sheet described in the XSL (XML Style Language) or the like is used. The data transmitting operation will be described in detail later.

A2. MFP 10

FIG. 2 is an external view of the MFP 10.

As shown in FIG. 2, the MFP 10 includes: an operating unit 11 having a plurality of keys l a, for receiving various instructions given by the user's operation on the keys and inputs of data such as characters and numbers; a display 12 for displaying information such as an instruction menu to the user and an image obtained; a scanner unit 13 for photoelectrically reading an original and obtaining image data; and a printer unit 14 for printing an image onto a recording sheet on the basis of the image data.

The MFP 10 also has: a feeder unit 17 which is provided on the top face of the body and feeds an original to the scanner unit 13; the paper feeding unit 18 which is provided in the lower part and supplies a recording sheet to the printer unit 14; a tray 19 which is provided in the center part and to which a recording sheet on which an image is printed by the printer unit 14 is ejected; a communication unit 16 which is provided on the inside and transmits/receives image data or the like to/from an external device via the network; and a storing unit 23 for storing the image data or the like. Although not shown, the MFP 10 has a network interface and the communication unit 16 is connected to a network via a network interface so as to transmit/receive various data to/from an external device.

The display 12 is used for displaying various images including a list of data transmission destinations, and the operating unit 11 is used for various inputs including selection of a transmission destination by the user. The display 12 is constructed as a liquid crystal type panel having therein a touch sensor or the like and can detect a position where a finger or the like of the operator touches in the display 12. The operator can therefore enter various instructions by depressing various virtual buttons and the like displayed in the display 12 with his/her finger or the like. The display 12 also has such an operation input function. The operating unit 11 and the display 12 function as main components of the user interface.

The scanner unit 13 obtains image data by photoelectrically reading image information of a picture, characters, a painting and the like from an original. The obtained image data (density data) is converted to digital data by a image processing unit (not shown) and subjected to known various image processes. After that, the resultant image data is transmitted to the printer unit 14 or communication unit 16 where the image is printed or data is transmitted, or stored into the storing unit 23 so as to be used later.

The printer unit 14 prints an image onto a recording sheet on the basis of the image data obtained by the scanner unit 13, the image data received from an external device by the communication unit 16, or the image data stored in the storing unit 23. The printer unit 14 can print not only the image data but also a text document (e.g., e-mail) received from an external device or the like. As described above, the printer unit 14 is a print output unit for performing various print outputs.

The communication unit 16 transmits/receives facsimile data via a public telephone line and transmits/receives data by using an electronic mail or the like to/from an external device connected to a network such as a LAN or the Internet via the network. Consequently, the MFP 10 has not only the function of a facsimile machine for performing normal facsimile communication but also the function of transmitting/receiving various data.

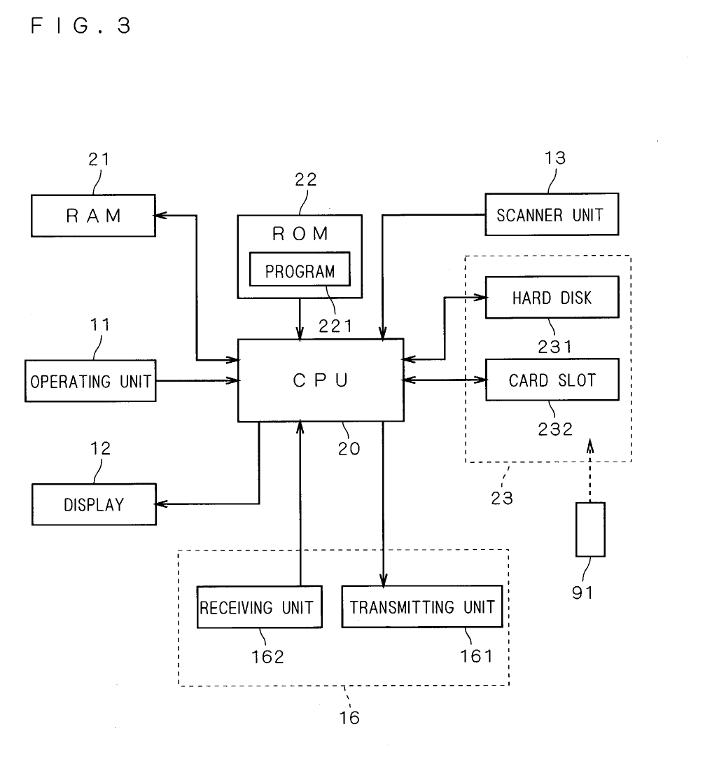

FIG. 3 is a block diagram showing a part mainly according to the preferred embodiment in the configuration of the MFP 10. The MFP 10 has a CPU 20 for performing various computing processes and controlling the whole operation of the MFP 10. A RAM 21 for storing various data and a ROM 22 for storing a predetermined software program (hereinafter, simply referred to as “program”) 221 are connected to the CPU 20. To the CPU 20, the operating unit 11, display 12, scanner unit 13 and storing unit 23 are also connected. The storing unit 23 is constructed by a hard disk 231 for storing image data and the like and a card slot 232 for reading information from a memory card 91. The RAM 21 is a nonvolatile memory (nonvolatile RAM).

With the configuration, under control of the CPU 20, various data can be transmitted/received among the RAM 21, scanner unit 13, hard disk 231, and the memory card 91 inserted to the card slot 232. On the display 12, by the control of the CPU 20, information stored in the RAM 21, hard disk 231 and memory card 91 is displayed.

Further, to the CPU 20, the communication unit 16 having a transmitting unit 161 and a receiving unit 162 for transmitting/receiving data to/from an external device connected via the network is also connected.

As described above, the MFP 10 is constructed as a computer system (hereinafter, simply referred to as “computer”) having the CPU 20 and the like. When a predetermined program is executed in such a computer, the MFP 10 functions as a data transmitter having functions to be described later.

Although the program 221 is stored in the ROM 22 in the preferred embodiment, the program 221 may be stored in the RAM 21. A program to be stored in the RAM 21 may be obtained by, for example, reading a program recorded in the memory card 91 as a recording medium from the memory card 91. Alternately, such a program may not be read directly from a recording medium such as the memory card 91 but may be loaded from an external device into the MFP 10 by communication via the network.

As shown in FIG. 1, the MFP 10 has, in addition to the transmitting unit 161, receiving unit 162 and the like, a data managing unit 31, a data generating unit 32, a style data storing unit 33 and the like. The functions of the units are realized by executing the program 221 by using hardware resources of the CPU 20, RAM 21, ROM 22, storing unit 23 and the like. The operations of the units will be described in detail later.

A3. External Device 50

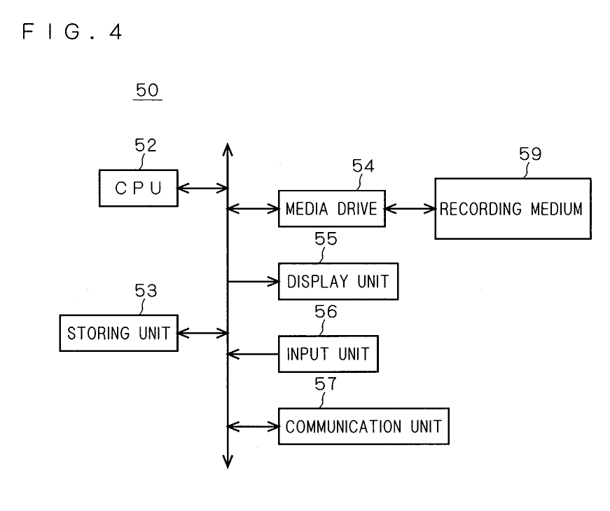

FIG. 4 is a block diagram showing the hardware configuration of the external device 50. As an example of the external device 50, a personal computer is illustrated. As shown in FIG. 4, the personal computer includes, as hardware, a CPU 52, a storing unit 53 having a main storage constructed by a semiconductor memory such as a RAM (and/or a ROM) and an auxiliary storage such as a hard disk driver (HDD), a media drive 54, a display unit 55 such as a display, an input unit 56 such as a keyboard and a mouse, and a communication unit 57 such as a network card.

The external device 50 is constructed so as to be able to transmit/receive a command and data to/from the MFP 10 by wireless or wired data communication or the like via the communication unit 57.

The media drive 54 reads information recorded in a portable recording medium 59 such as a CD-ROM, DVD (Digital Versatile-Disk), flexible disk or memory card.

By reading a program recorded on the recording medium 59 and executing the program by using the CPU 52 and the like, the external device 50 functions as a data receiver capable of displaying device information. It is not limited to the case that the program having functions is supplied (or distributed) via the recording medium 59 but the program may be supplied (or distributed) to the computer via a network such as the LAN and the Internet.

As shown in FIG. 1, the external device 50 further includes a transmitting unit 61, a receiving unit 62, a style data storing unit 63 and a display control unit 64. The functions of the units are realized by using hardware resources of the CPU 52, communication unit 57, storing unit 53 and the like. The operations of the units will be described in detail later.

A4. Operations

Referring now to FIG. 1 and FIGS. 5 to 9, and so on, the operation of transmitting/receiving device information by using the MFP 10 and the external device 50 will be described.

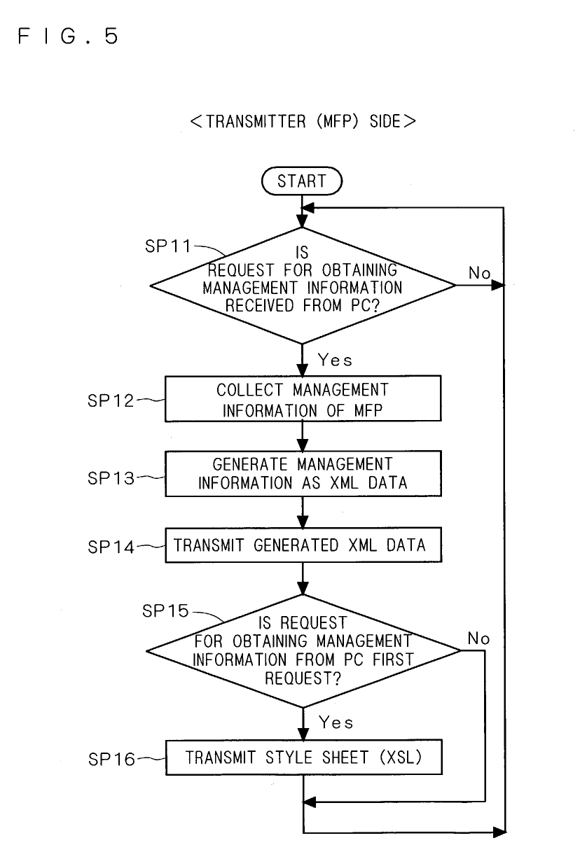

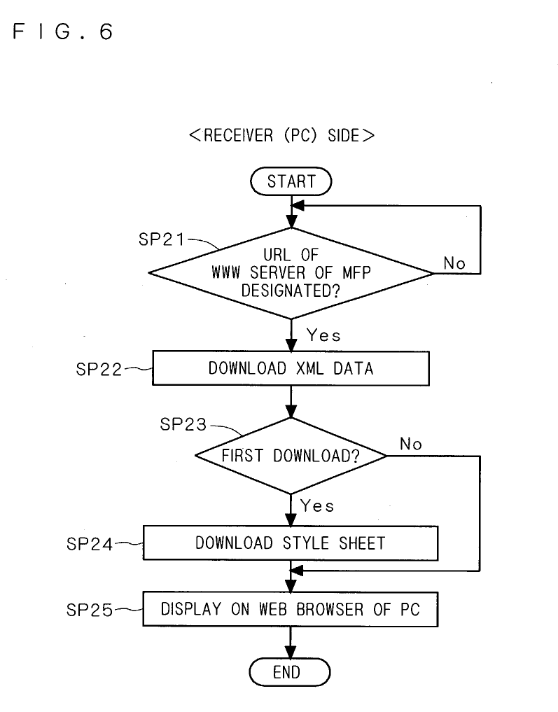

FIG. 5 is a flowchart showing the operation of the MFP (data transmitter) 10. FIG. 6 is a flowchart showing the operation of the computer (data receiver) 50.

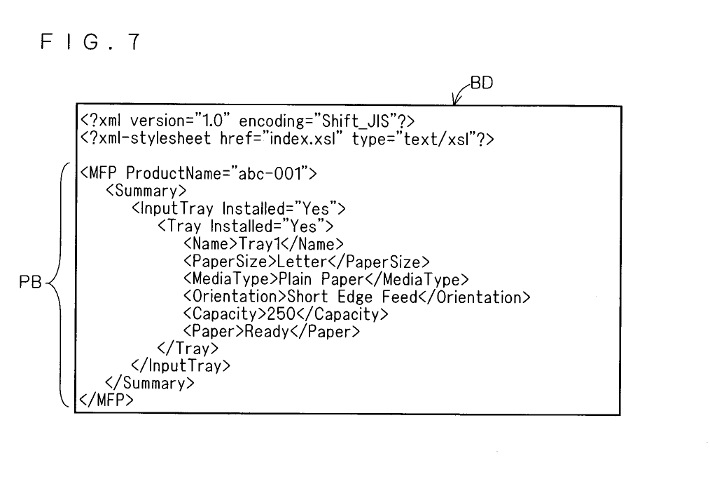

FIG. 7 is a diagram showing an example of body data transmitted/received in the operation. Data described in the XML (XML data BD) is illustrated as an example of the “body data”. For simplicity of description, FIG. 7 shows the case where only “tray 1” (the first paper tray) is described as the XML data BD. Concretely, with respect to the “tray 1 (Tray1)”, the paper size is “letter size (Letter)” and the type of paper is “plain paper (Plain Paper)” are written. Similar data may be transmitted with respect to each of the plurality of paper trays.

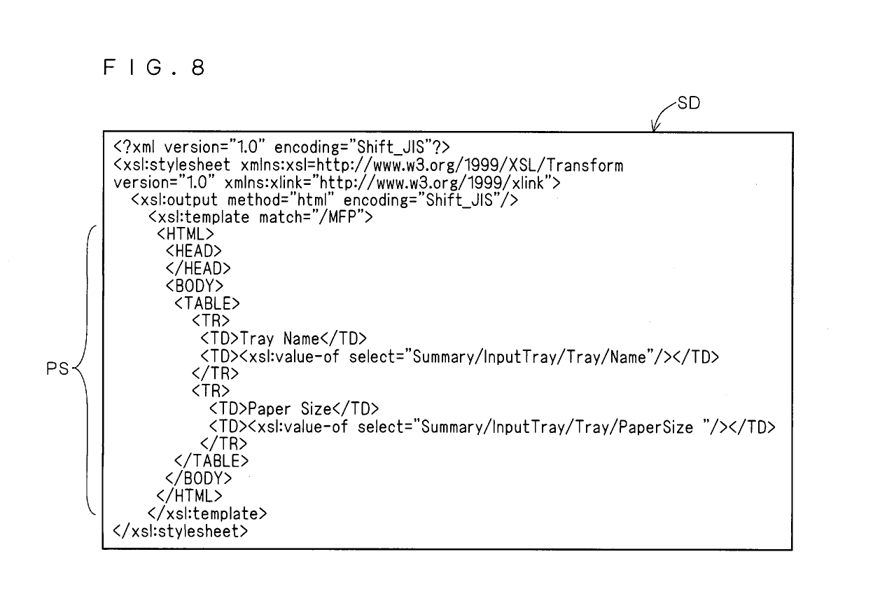

FIG. 8 shows an example of style data SD used for a displaying operation in the external device 50. In the diagram, a style sheet described in the XML is shown as “style data”. In the style data SD, a part PB sandwiched by tags <MFP> and </MFP> in the XML data BD is replaced with description of a part PS in the style data SD and is formed as an HTML document. Consequently, the XML data BD is displayed in the display format of the part PS on the display unit 55. The part PS describes that a table is displayed in which the item name of “Tray Name” and data of the item (components of “Summary/InputTray/Tray/Name” in the XML data BD) are arranged in the upper part, and the item name of “Paper Size” and data of the item (components of “Summary/InputTray/Tray/PaperSize” in the XML data BD) are arranged in the lower part.

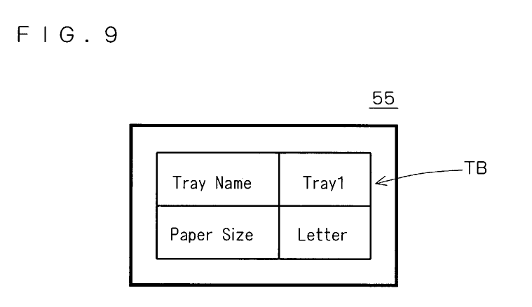

FIG. 9 shows an example of display on the display unit 55 in the computer 50. When the style data SD shown in FIG. 8 is applied to the XML data (body data) of FIG. 7, data is displayed as shown in FIG. 9. Such display is made on the basis of the description of the part PS in the style data SD. Concretely, it is described that a table is displayed in which the item name of “Tray Name” and data of the item (“Tray 1”) are arranged in the upper part, and the item name of “Paper Size” and data of the item (“Letter”) are arranged in the lower part.

With reference to FIGS. 1 and 5, the operation of the MFP 10 on the transmission side will be described.

In step SP11 (FIG. 5), the MFP 10 checks whether a request for obtaining management information from the computer 50 exists or not. Concretely, a check is made to see whether the receiving unit 162 (FIG. 1) of the MFP 10 has received request data RQ of the computer 50 or not. The request data RQ is transmitted from the transmitting unit 61 of the computer 50 to the MFP 10 in step SP21 which will be described later.

In the case where reception of the request data RQ is recognized, the program advances to step SP12. On the other hand, when reception is not recognized, the process of step SP11 is repeatedly performed.

In step SP12, the MFP 10 collects device information (management information) of the MFP 10 itself. Concretely, the data generating unit 32 of the MFP 10 acquires various information stored in the data managing unit 31 (FIG. 1) in the MFP 10.

In step SP13, the data generating unit 32 generates the XML data BD on the basis of the obtained various information. As described above, the XML data BD (see FIG. 7) is body data specifying the device information itself.

The generated XML data BD is transmitted by the transmitting unit 161 to the computer 50 in step SP14.

In step SP15, whether the request received in step SP11 is the first request from the computer 50 as a requester or not is determined.

If it is determined that the request is the first request from the computer 50 as a requester, the program advances to step SP16 where the style data SD (see FIG. 8) is transmitted to the computer 50. More specifically, the style data SD is transmitted by the transmitting unit 161 of the MFP 10 and received by the receiving unit 62 of the computer 50.

On the other hand, if the request is not the first request, the program returns to step SP11 without transmitting the style data SD. That is, when it is determined that the request from the computer 50 is the second or later request in step SP15, the MFP 10 transmits only the XML data BD out of two pieces of data of the XML data BD and the style data (style sheet) SD to the computer 50.

After that, the processes in step SP11 and subsequent steps are repeatedly executed.

The operation of the computer 50 on the reception side will now be described with reference to FIG. 6.

First, in step SP21, the computer 50 transmits a request for transmitting the device information to the computer 50 to the MFP 10. Concretely, by designating a predetermined URL (Uniform Resource Locator) of the MFP 10 in an XML browser started on the computer 50, data of the device information corresponding to the URL is designated as data to be viewed. In response to the request, the MFP 10 performs the operation of step SP11.

After that, the receiving unit 62 of the computer 50 receives the XML data BD transmitted from the MFP 10 (step SP22). That is, the XML data BD is downloaded. If it is the first download, the style data (style sheet) SD is also received (steps SP23 and SP24). The received style data SD is stored in the style data storing unit 63.

The display control unit 64 of the computer 50 generates a display output signal for displaying the received XML data BD in a display format specified in the style data SD and outputs the display output signal to the display unit 55. The display unit 55 displays an image according to the display output signal. In such a manner, the device information of the MFP is displayed in the proper display format on the display unit 55.

As the style data SD used to determine the display format, the received style data SD is used for the XML data BD at the time of the first download. For the XML data BD at the time of the second or later download, it is sufficient to use the style data SD stored in the style data storing unit 63.

In such a manner, the operation of transmitting/receiving the device information in the preferred embodiment is performed.

In the preferred embodiment, the MFP 10 transmits the XML data BD and the style data (style sheet) SD at the time of the first transmission and transmits only the XML data BD out of the data BD and SD at the time of update transmission of the device information (at the time of the second or later transmission). As described above, at the time of update transmission, only the XML data BD of the device information is transmitted separately from the style data SD. That is, at the time of update transmission, the style data SD is not transmitted, so that communication traffic at the time of update transmission of the device information can be suppressed.

Also in the following operation of updating the device information, by repeatedly transmitting only the XML data BD out of the data BD and SD, the device information displayed on the computer 50 can be updated. Therefore, when the updating operation is repeatedly performed, communication traffic can be further suppressed. As the number of repeating times of the updating operation increases, the communication traffic can be further suppressed.

B. Second Preferred Embodiment

In a preferred second embodiment, style data SD11 in which a display format at the time of displaying on the computer 50 can be selected from a plurality of display formats (for example, two display formats SL1 and SL2) will be used as the style data (style sheet). By using the style data SD11, data can be displayed in a display format more flexibly.

The MFP 10 and computer 50 of the second preferred embodiment have the configuration similar to that of the first preferred embodiment and perform similar operations but a style sheet used for display on the computer 50 is different from the first preferred embodiment. The different point will be mainly described below.

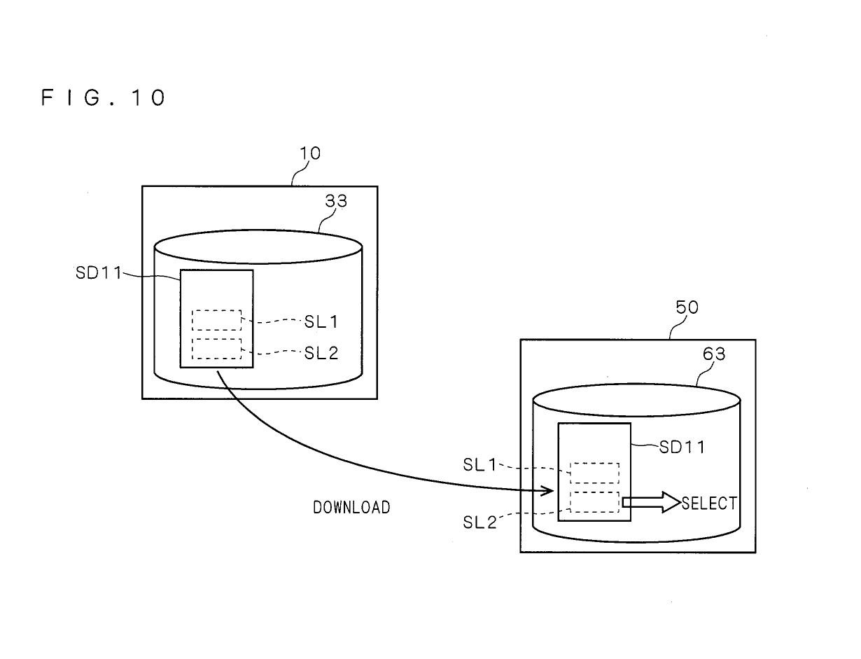

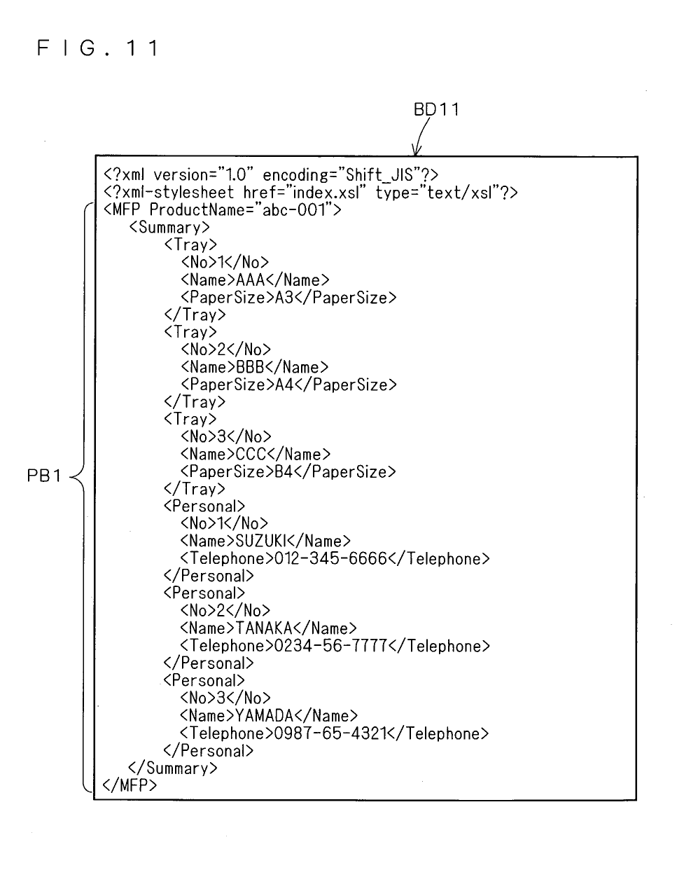

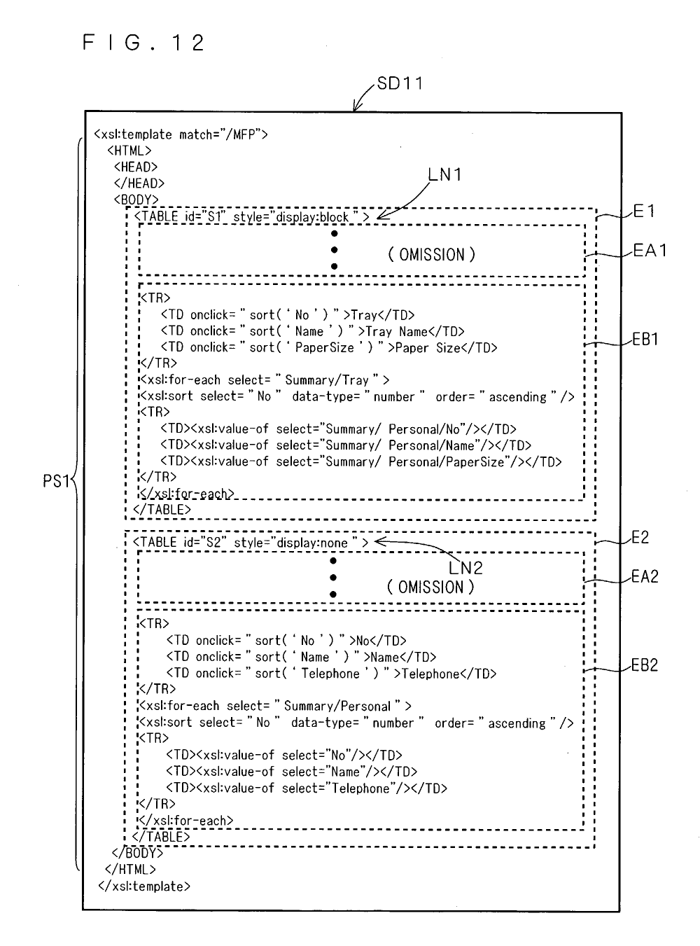

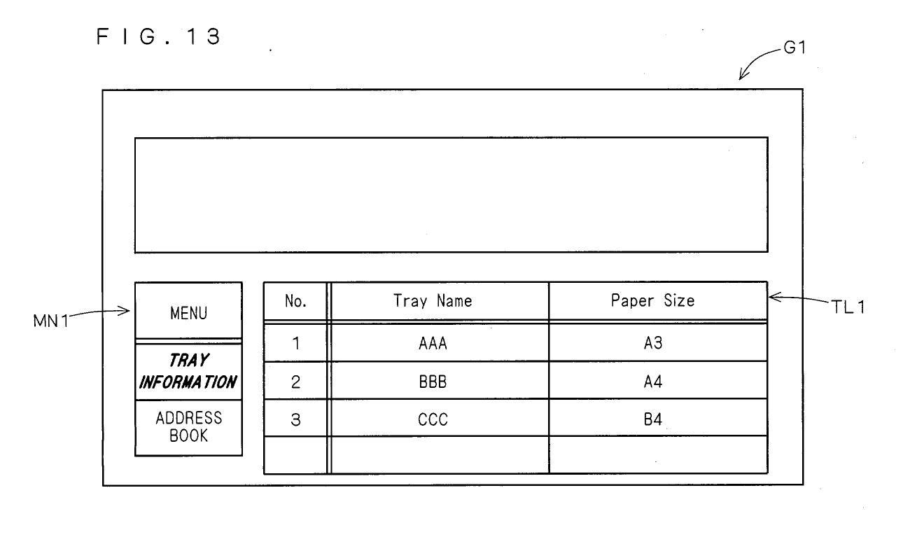

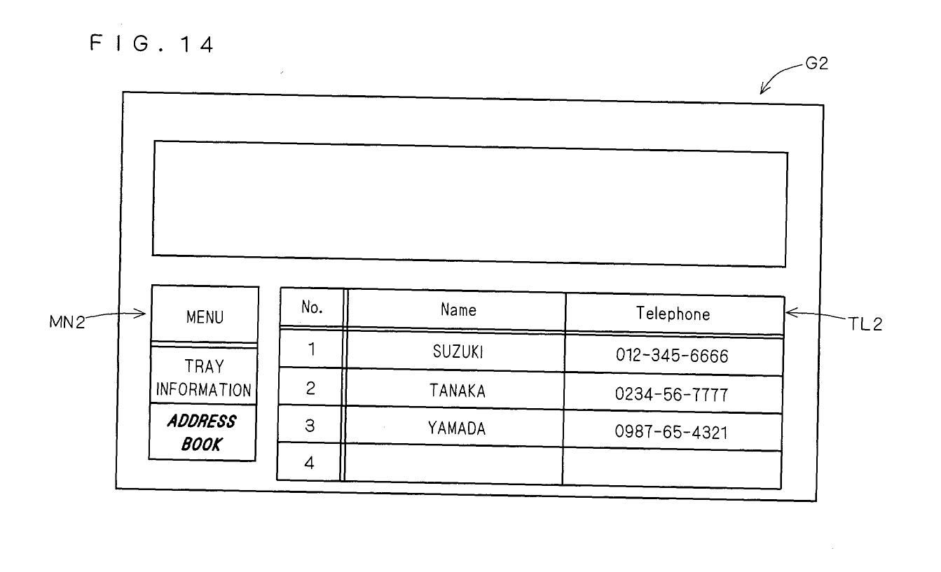

FIG. 10 is a diagram for describing the operation in the second preferred embodiment. FIG. 11 is a diagram showing XML data BD11 transmitted in the second preferred embodiment. FIG. 12 is a diagram showing the style data SD11 used in the second preferred embodiment. Further, FIG. 13 shows a screen GI displayed in the display format SL1 and FIG. 14 shows a screen G2 displayed in the display format SL2.

In the second embodiment, operation of transmitting/receiving device information is performed in a procedure similar to that in the first preferred embodiment. In steps SP16 and SP14, one piece of style data SD11 is transmitted from the MFP 10 to the computer 50. As shown in FIG. 10, the plurality (two, in this case) of display formats SL1 and SL2 which can be selected are preliminarily described in the style data SD11. When the operator (user) of the computer 50 selects a desired display format from the plurality of display formats SL1 and SL2 preliminarily described in the style data SD11, the computer 50 displays the device information in the display format selected by the user. Concretely, the computer 50 arranges the XML data BD on the basis of the selected display format and displays the resultant on the display unit 55. Since the plurality of display formats which can be selected are specified in the style data SD11 already obtained by the computer 50 side, it is unnecessary to transmit new style data from the MFP 10 to the computer 50.

As shown in FIG. 11, the XML data BD11 is data specifying the device information itself. Concretely, the substance of the device information is specified in a part PB1. For example, in a part sandwiched by tags <Tray> and </Tray> of the XML data BD11, information of each paper tray in the MFP 10 is described. In a part sandwiched by tags <Personal> and </Personal>, information of each of persons listed in an address book is described. FIG. 11 shows the case where information of three paper trays and personal information of three persons is described.

The data specifying the display format of the device information is not included in the XML data BD11 but is included in the style data SD11.

The style data SD11 includes description of the two display formats SL1 and SL2. Concretely, description of specifying the display format SL1 is included in a part E1 and description of specifying the display format SL2 is included in a part E2. When the operation of arranging the XML data BD11 is performed on the basis of the description in the part E1, the screen G1 (FIG. 13) is displayed on the display unit 55 of the computer 50. When the operation of arranging the XML data BD11 is performed on the basis of the description in the part E2, the screen G2 (FIG. 14) is displayed on the display unit 55 of the computer 50. As will be described later, the operator can select the display format to be used for display from the two display formats SL1 and SL2 by operating an input device such as the mouse or keyboard.

First, the display format SL1 will be described. In a line LN1 in the part E1 (FIG. 12), it is described that the identification code of the display format is S1 (id=s1) and the display format is a display format (default display format) used for the first display (style=“display:block”). At the time of the first display in the computer 50, according to the description, device information is displayed in the display format SL1 (not the display format SL2).

In a part EB1, data for displaying a table TL1 on the lower right side of FIG. 13 is described. In the part EB1, it is specified that items of “Tray”, “Tray Name” and “Paper Size” are displayed in this order in the upper part of the table TL1 and data of “No”, “Name” and “PaperSize” regarding each paper tray is displayed below the items. As a result, in the table TL1 of FIG. 13, tray numbers (1, 2 and 3) of the paper trays are displayed below the item of “Tray” and data (AAA, A3, BBB, A4, CCC and B4) regarding the paper trays is displayed below the items “Tray Name” and “Paper Size”.

Although the details are not shown in FIG. 12 for simplicity of the figure, data for displaying a menu MN1 (the lower left side of FIG. 13) in a table format is described in the part EA1. In the part EA1, a predetermined script (for example, JAVA (TM) script) is also described. When the script is executed, an entry from the operator with the mouse of the computer 50 is accepted and the display format can be switched according to the input. More concretely, the display format can be changed according to the identification code (S1 or S2) included in the accepted entry information. As a result, a change from the display format SL1 to another display format SL2 can be realized. The present invention is not limited to the method. It is also possible to describe a declaration statement that predetermined software (such as JAVA (TM) applet) is to be executed, and to call and execute the software, thereby accepting an operation input by the mouse.

The display format SL2 will now be described. In a line LN2 in the part E2 (FIG. 12), it is described that the identification code of the display format is S2 (id=s2) and the display format is not used for the first display (style=“display:none”).

In the part EB2, data for displaying a table TL′ on the lower right side in FIG. 14 is described. In the part EB2, it is specified that items “No.”, “Name” and “Telephone” are displayed in this order in the upper part of the table TL2 and data of “No.”, “Name” and “Telephone” regarding personal information is displayed below the corresponding items. As a result, in the table TL2 of FIG. 14, identification numbers (1, 2 and 3) of persons are displayed below the item “No.” and data regarding names and telephone numbers of personal information is displayed below the items “Name” and “Telephone”.

Although the details are not shown for simplicity of the figure in FIG. 12, data for displaying a menu MN2 in a table format (the lower left side of FIG. 14) is described in the part EA2. In the part EA2, in a manner similar to the part EA1, a predetermined script (for example, JAVA (TM) script) is also described. When the script is executed, an entry from the operator with the mouse of the computer 50 is accepted and the display format can be switched according to the entry. As a result, a change from the display format SL2 to another display format SL1 is realized.

As described above, the style data SD11 includes the plurality of display formats SL1 and SL2 which can be selectively used for display on the display unit 55 of the computer 50. Therefore, the operator can select the display format more flexibly. The style data SD11 is transmitted at least once from the MFP 10 to the computer 50 and, after that, stored in the style data storing unit 63. Consequently, at the time of re-transmission of the XML data BD11, it is unnecessary to transmit the style data SD11 again. The display control operation in the display unit 55 of the computer 50 can be realized on the basis of the style data SD11 received in advance. Since the style data SD11 includes data specifying a plurality of display formats, also at the time of a change in the display format, the style data SD11 does not have to be re-transmitted (or re-received).

In a conventional system as described above, as data for displaying device information, HTML data is transmitted/received. The HTML data is data including both the data itself and the display format of the data. The HTML data is generated on condition that it is displayed in a fixed display format specified by the description, so that flexibility of display in a personal computer or the like on the reception side of displaying data is regulated. In order to deal with the problem, it is also possible to improve the flexibility of display by preparing HTML data in various display formats and displaying the HTML data in a display format selected from the plurality of HTML data. However, HTML data including not only the data itself but also the display format of the data is still sequentially transmitted/received, so that an effect of suppressing communication traffic cannot be expected.

In contrast, according to the system of the preferred embodiment, a flexible display format can be specified in the style data SD and, in addition, by re-transmitting only the XML data BD11 specifying the data itself of the device information, communication traffic can be suppressed.

C. Third Preferred Embodiment

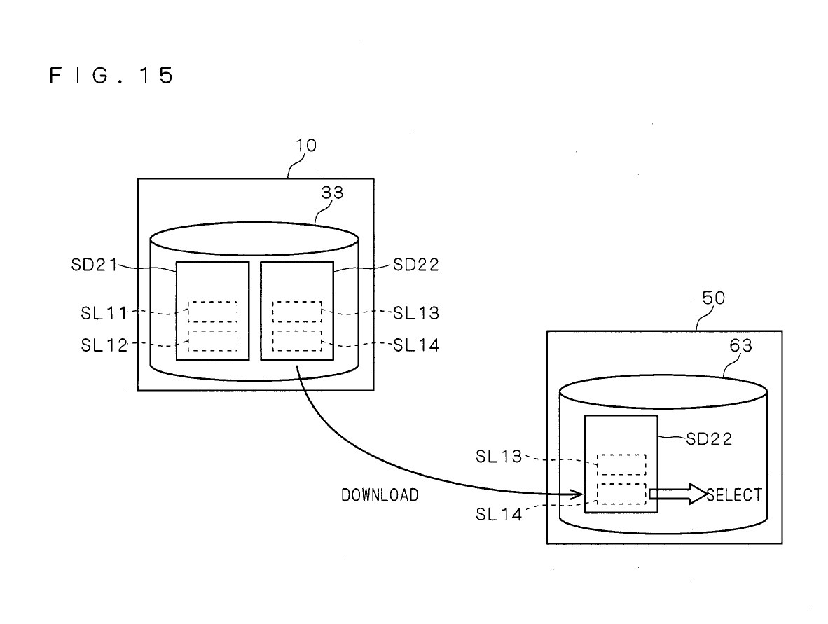

FIG. 15 is a diagram for describing operation in a third preferred embodiment. The MFP 10 and computer 50 of the third preferred embodiment have the configuration similar to that of the first preferred embodiment and perform similar operations but style data SD used for display on the computer 50 is different from the first embodiment. The different point will be mainly described below.

In the third embodiment, a case where style data selected from a plurality (two, in this case) of style data SD21 and SD22 is transmitted to the computer 50 and information is displayed on the computer 50 on the basis of the transmitted style data will be described. In a manner similar to the second preferred embodiment, each of the style data SD21 and SD22 have two display formats which can be selected. Concretely, the style data SD21 has two display formats SL11 and SL12, and the style data SD22 has two display formats SL13 and SL14. Therefore, the operator (user) can select a desired display format from the four formats SL11, SL12, SL13 and SL14.

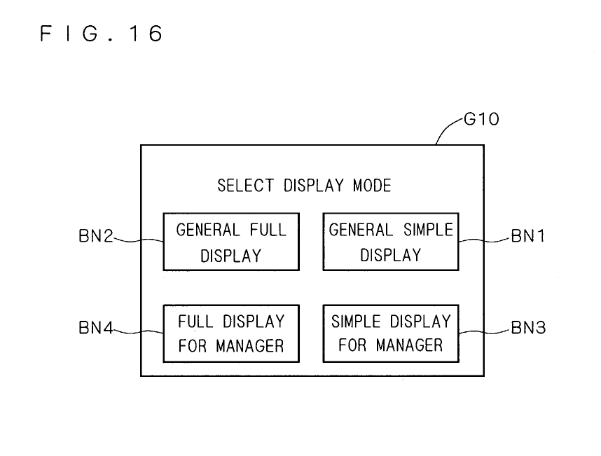

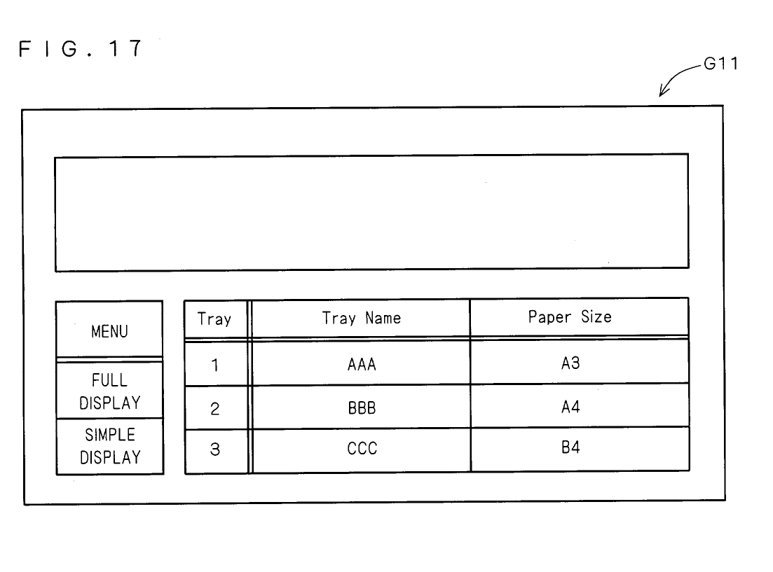

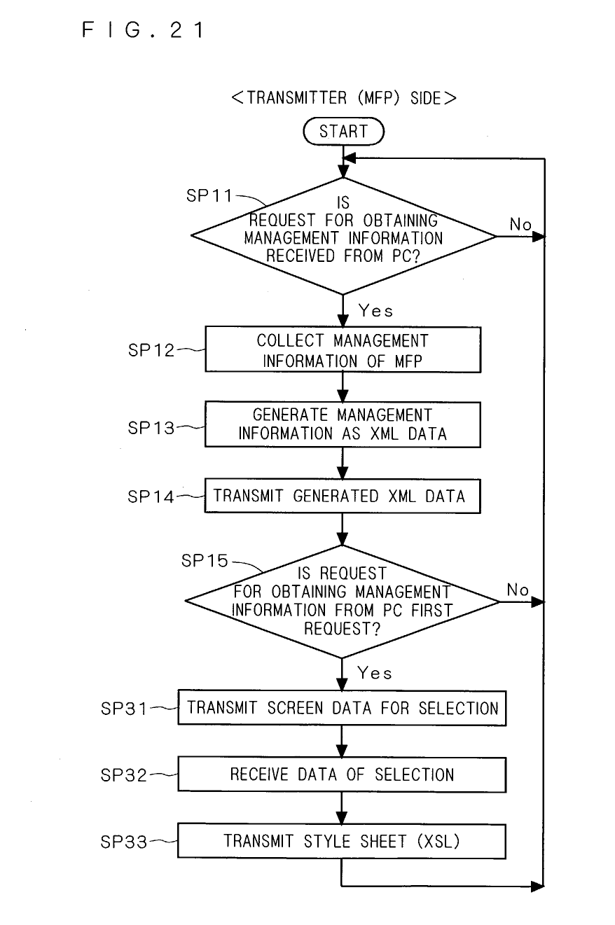

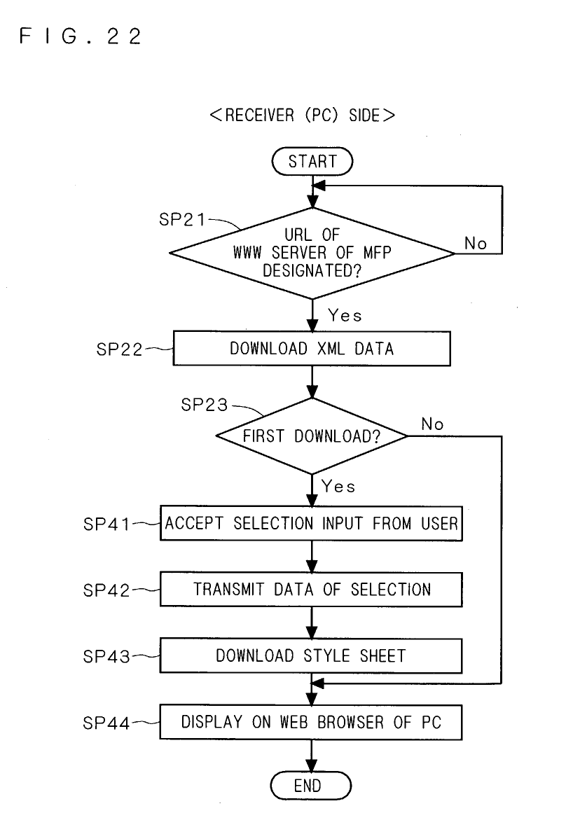

FIG. 16 is a diagram showing a screen G10 for urging the user to select a display format. FIGS. 17 to 20 are diagrams showing screens G11 to G14 displayed in display formats SL11 to SL14, respectively. FIG. 21 shows the operation of the MFP 10 and FIG. 22 shows the operation of the computer 50. In FIGS. 21 and 22, the same step numbers are designated to operations similar to those in the flowcharts of FIGS. 5 and 6.

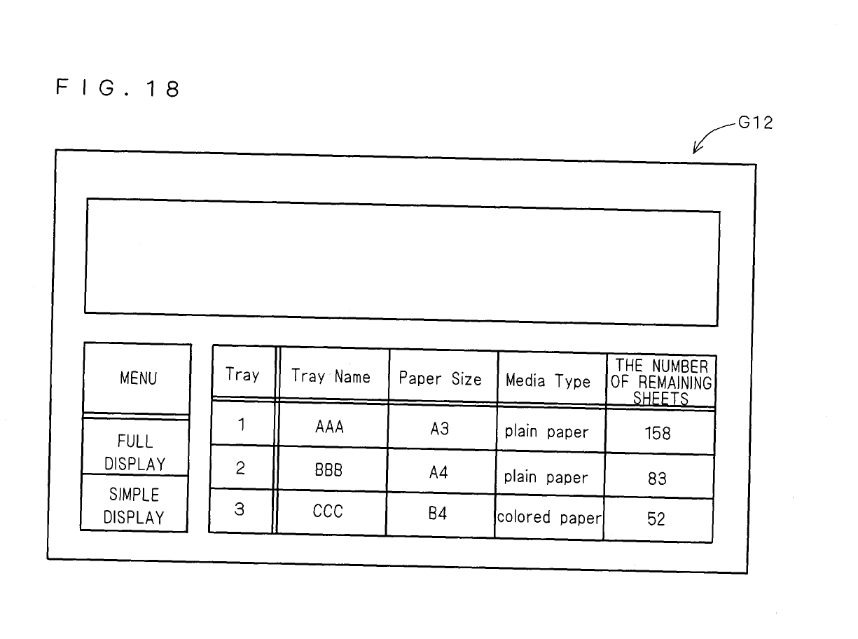

As shown in the screens G11 and G12 of FIGS. 17 and 18, the display formats SL11 and SL12 are display formats for general users. As user information, information regarding “paper tray” in the device information is displayed. The display format SL11 is a display format of a simple type (simple display) and the display format SL12 is a display format of a type of displaying detailed information (full display). More specifically, in the screen G11 (FIG. 17) of simple display, in the information of the paper trays, information of “Tray Number”, “Tray Name” and “Paper Size” is displayed. In the screen G12 of full display (FIG. 18), detailed information regarding the paper trays including the information of “Tray Number”, “Tray Name” and “Paper Size” and, in addition, information regarding “Media Type” and “the number of remaining sheets (remaining amount)” is displayed. On each of the screens G11 and G12, menu buttons for switching the display between “full display” and “simple display” are displayed. The operator can switch the display format by clicking the menu button.

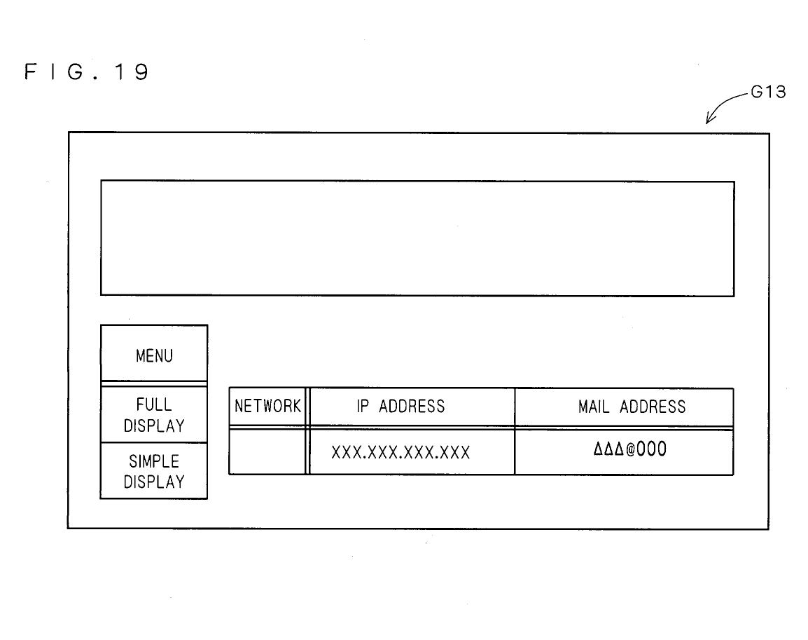

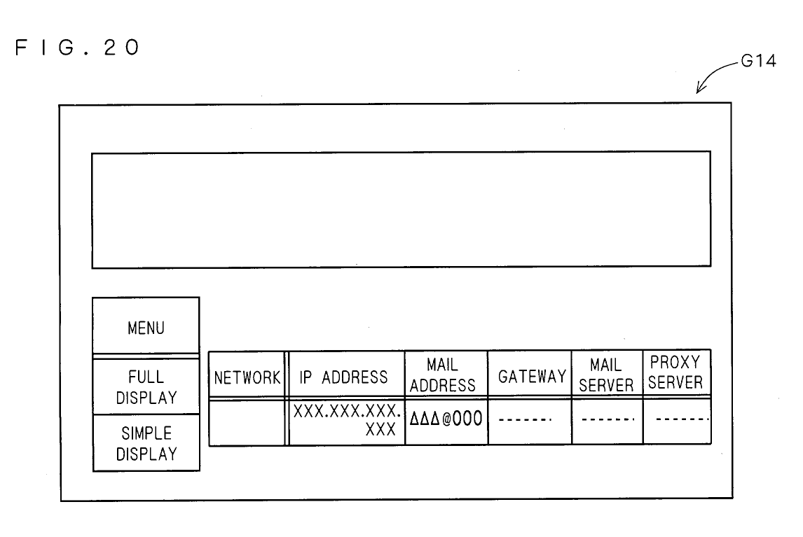

As shown in the screens G13 and G14 of FIGS. 19 and 20, the display formats SL13 and SL14 are display formats for a manager. As an example, information regarding “network settings” in the device information is displayed as the information for a manager. The display format SL13 is a display format of the simple type (simple display), and the display format SL14 is a display format of a type of displaying detailed information (full display). More specifically, in the screen G13 (FIG. 19) of simple display, information regarding “IP address” and “mail address” in the information regarding network settings is displayed. In the screen G14 (FIG. 20) of full display, detailed information regarding network settings including the information of “IP address” and “mail address” and, in addition, information of a gateway, a mail server, and a proxy server is displayed. In each of the screens G13 and G14 and so on, menu buttons for switching display between “full display” and “simple display” are displayed. The operator can switch the display format by clicking the menu buttons by a mouse operation.

In the XML data BD transmitted/received in the third preferred embodiment, the information (various information regarding trays and various information regarding network settings) is described. From the various information, according to the display format selected by the user, information is selected and displayed.

The operation in the preferred third embodiment will now be described.

As shown in FIGS. 21 and 22, when a request from the computer 50 is received, the MFP 10 transmits data of the screen G10 for selecting the display format (FIG. 16) to the computer 50 in step SP31 subsequent to step SP15. In step SP41 subsequent to step SP23, the computer 50 displays the screen G10 for selecting a display format on the display unit 55 and accepts a selection input from the user.

In the screen G10 for selecting a display format in FIG. 16, the user selects a desired option from the four options (concretely, “general full display”, “general simple display”, “full display for manager” and “simple display for manager”). Concretely, the user selects and clicks any of buttons BN1 to BN4 displayed on the screen by a mouse operation or the like. The computer 50 sends the data of selection input of the user by the mouse operation or the like (in other words, the information as to which option is selected) to the MFP 10 (step SP42).

The MFP 10 receives the data of selection input (step SP32) and transmits style data (style sheet) according to the data of selection input to the computer 50 (step SP33). For example, when the button BN1 or BN2 is clicked and a message indicating that the display format SL11 or SL12 (that is, “general simple display” or “general full display”) is selected is transmitted from the computer 50, the MFP 10 determines that the style data SD21 for general user is selected and transmits the style data SD21 to the computer 50. On the other hand, when the button BN3 or BN4 is clicked and the display format SL13 or SL14 (i.e., “simple display for manager” or “full display for manager”) is selected, the MFP 10 determines that the style data SD22 for manager is selected and transmits the style data SD22 to the computer 50.

After that, the computer 50 receives the style data SD transmitted from the MFP 10 (step SP43), arranges the XML data BD on the basis of the received style data, and displays the device information in a predetermined format on the display unit 55 (step SP44). The computer 50 stores the data as to which option (“full display” or “simple display”) is selected in step SP41 in a memory, determines that the device information is displayed in the “full display” or “simple display” in accordance with the stored data, and displays the information accordingly. For example, when “general full display” is selected in step SP41, the style data SD21 is transmitted from the MFP 10 to the computer 50. The computer 50 employs the display format SL11 specified in the style data SD21 and displays the information on the display unit 55.

As described above, the computer 50 can display device information in various display formats. Further, since style data is not transmitted at the time of re-transmission of XML data, communication traffic can be suppressed.

In the third preferred embodiment, the case of selecting a display format for the first display screen of the device information on the basis of the selection screen G10 as shown in FIG. 16 has been described; however, the present invention is not limited thereto. Concretely, the display format may be determined on the basis of the default set value described in each style data. For example, the computer 50 displays a selection screen on the display unit 55 for allowing the user to select either “display for general user” or “display for manager” and accepts a selection input, thereby determining either “display for general user” or “display for manager” and determining either simple display or full display by using the default display format (display format specified to be employed first) in style data corresponding to the selection input.

D. Others

Although the case where the MFP 10 transmits device information of the MFP 10 itself has been described in the above-described preferred embodiments, the present invention is not limited thereto. For example, a controller, provided separately from the MFP 10 and connected to the MFP 10 so that communication can be performed between the controller and the MFP 10, may obtain device information of the MFP 10 from the MFP 10 via a communication line or the like and transmit the device information to another external device 50. In this case, the controller functions as a data transmitter and various information of the MFP 10 connected to the controller is transmitted as “device information”. As described above, the “device information” to be transmitted/received may be any information regarding a device (such as MFP) associated with the data transmitter (such as the controller).

Although the case where each operation of transmitting the XML data BD is performed in response to the respective request (step SP21) of the computer 50 as shown in FIG. 5 has been described in each of the above-described preferred embodiments, the present invention is not limited thereto. For example, the XML data BD may be repeatedly transmitted regularly or irregularly in response-to one request. In this case as well, at the time of update transmission, by transmitting only the XML data BD without sending the style data SD, communication traffic can be suppressed.

Further, the case where two display formats are described in one style data SD has been described in the second preferred embodiment, three or more display formats may be described. For example, information may be displayed in a display format selected from four display formats of the display format SL1 for displaying tray information, the display format SL2 for displaying addresses, in addition, a display format for displaying a transmission history (transmission history in facsimile communication or the like), and a display format for displaying a network setting screen. In this case, the four display formats are included in one style data SD11. The display formats can be switched by operation on the menu part. For example, it is sufficient to display four options (concretely, “tray information”, “address book”, “transmission history” and “network settings”) in the menu MN1 (see FIG. 13 or the like) and allow the user to select one of the four display formats. In this case as well, style data including the four display formats which can be selected is stored already stored in the computer 50 at the time of update transmission of the XML data BD11. Therefore, without re-transmitting the style data from the MFP 10 to the computer 50, the display format in the computer 50 can be changed. In such a manner, while suppressing communication traffic, the display format of a screen can be changed flexibly.

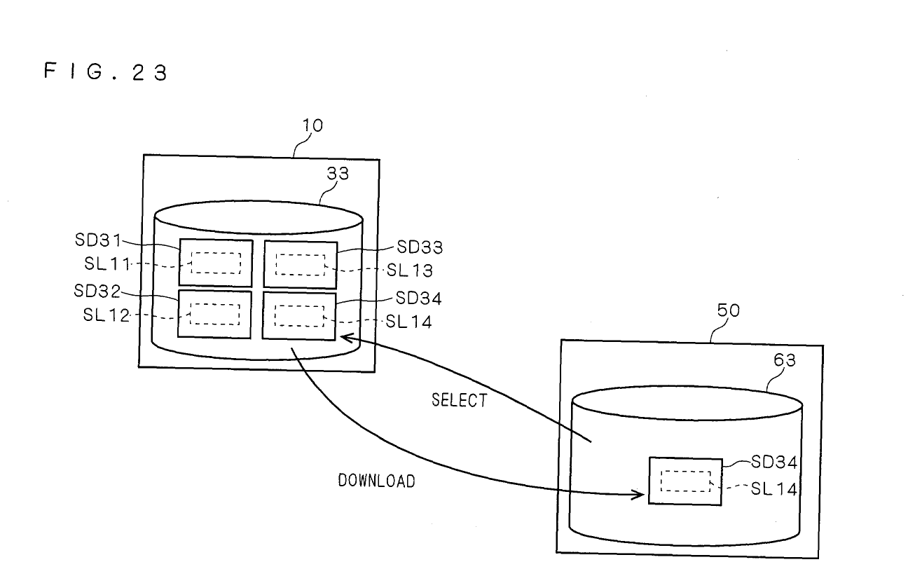

In the third preferred embodiment, the case of realizing total four display formats by the two style data SD21 and SD22 each having two display formats has been described. However, the present invention is not limited thereto. For example, as shown in FIG. 23, it is also possible to specify four display formats in different style data SD31 to SD34 and download style data selected by the operator of the computer 50 from the four style data SD31 to SD34 from the MFP 10 to the computer 50.

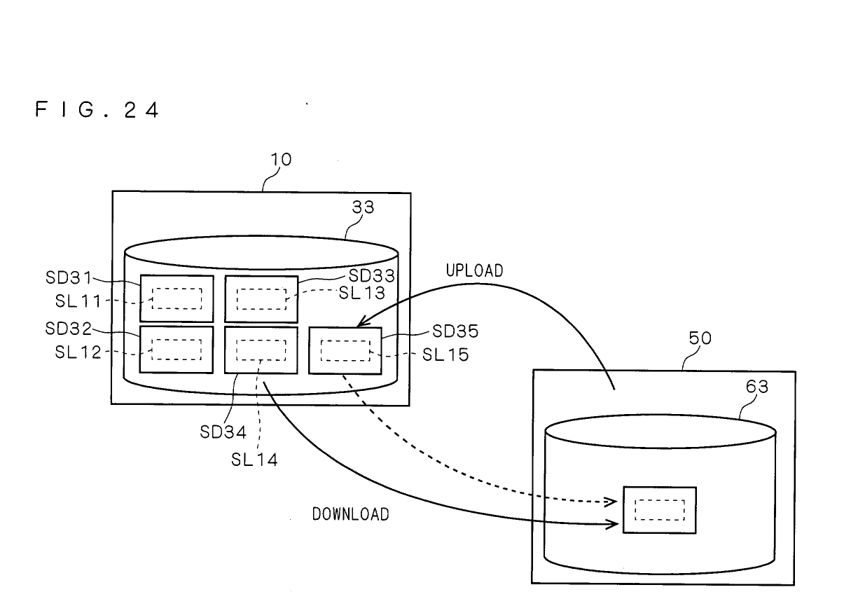

Alternately, the following method is also possible. As shown in FIG. 24, not only the display formats prepared on the MFP 10 side but also style data SD35 generated by the user of the computer 50 or the like is uploaded from the computer 50 to the MFP 10 in advance. The style data corresponding to a desired display format is selected by the user from total five pieces of style data of the four style data SD31 to SD34 prepared on the MFP 10 side and the style data SD35. And the selected style data is transmitted from the MFP 10 to the computer 50.

In the exemplary preferred embodiments described above, style data is transmitted in the first transmission, and no transmission of the style data occurs in the second transmission and in transmissions subsequent thereto. However, the present invention is not limited to these. For example, the style data may be transmitted in the second transmission, and only the body data but not the style data may be transmitted in the third transmission and in transmissions subsequent thereto.

While the invention has been shown and described in detail, the foregoing description is in all aspects illustrative and not restrictive. It is therefore understood that numerous modifications and variations can be devised without departing from the scope of the invention.

What is claimed is:

1. A data transmitting apparatus comprising:
a generating part for obtaining device information regarding a predetermined device and generating body data specifying said device information itself;
a receiving part for receiving a request to transmit said device information from an external device;
a transmitting part for transmitting data;
a storing part for storing style data specifying a display format of said device information; and
a controller for transmitting both said body data and said style data in a preceding transmission responding to said request, and for transmitting only said body data but not said style data in transmissions subsequent to the preceding transmission.

2. The data transmitting apparatus according to claim 1, wherein said body data is XML data, and said style data is a style sheet.

3. The data transmitting apparatus according to claim 1, wherein said device information is information regarding said data transmitting apparatus.

4. The data transmitting apparatus according to claim 1, wherein said device information is information regarding another device associated with said data transmitting apparatus.

5. The data transmitting apparatus according to claim 1, wherein said style data includes a plurality of pieces of data specifying display formats of said device information.

6. The data transmitting apparatus according to claim 1, wherein said storing part stores a plurality of pieces of style data, and said controller transmits said body data and one piece of style data selected by said external device among said plurality of pieces of style data in said preceding transmission.

7. The data transmitting apparatus according to claim 1, wherein said preceding transmission is the first transmission.

8. A data receiving apparatus comprising:
a receiving part for receiving data;
a transmitting part for transmitting data;
a storing part for storing data; and
a controller for transmitting a request to transmit device information regarding a predetermined device to a data transmitting apparatus, storing style data specifying a display format of said device information into said storing part, receiving body data specifying said device information itself transmitted from said data transmitting apparatus in response to said request, and displaying said body data in accordance with said display format specified in said style data.

9. The data receiving apparatus according to claim 8, wherein said body data is XML data, and said style data is a style sheet.

10. The data receiving apparatus according to claim 8, wherein said device information is information regarding said data transmitting apparatus.

11. The data receiving apparatus according to claim 8, wherein said device information is information regarding another device associated with said data transmitting apparatus.

12. The data receiving apparatus according to claim 8, further comprising
a display for displaying said device information.

13. A computer program product used in a data transmitting apparatus, the computer program product including the instructions of:
a) obtaining device information regarding a predetermined device from said predetermined device, and generating body data specifying the device information itself, in response to a request to transmit said device information from an external device; and
b) transmitting both said body data and style data specifying a display format of said device information to said external device in a preceding transmission responding to said request, and transmitting only said body data but not said style data in transmissions subsequent to the preceding transmission.

14. The computer program product according to claim 13, wherein said body data is XML data, and said style data is a style sheet.

15. The computer program product according to claim 13, wherein said device information is information regarding said data transmitting apparatus.

16. The computer program product according to claim 13, wherein said device information is information regarding another device associated with said data transmitting apparatus.

17. The computer program product according to claim 13, wherein said style data includes a plurality of pieces of data specifying display formats of said device information.

18. The computer program product according to claim 13, wherein said instruction b) includes sub-instruction of:
b-1) inquiring of said external device as to which one of said plurality of pieces of said style data is to be selected, and transmitting said style data selected by said external device, in said preceding transmission.

19. The computer program product according to claim 13, wherein said preceding transmission is the first transmission.
